(19) United States
(12) Patent Application Publication
(10) Pub. No.: US 2011/0261267 A1
(43) Pub. Date: Oct. 27, 2011

(54) ELECTRONIC DEVICE AND METHOD OF CONTROLLING THE SAME

(76) Inventors: Jaehong KIM, Seoul (KR); Haesoo LEE, Seoul (KR)

(21) Appl. No.: 13/084,914

(22) Filed: Apr. 12, 2011

(30) Foreign Application Priority Data
Apr. 22, 2010 (KR) 10-2010-0037537

(51) Int. Cl. H04N 5/63

(52) U.S. Cl. 348/730; 348/E05.127

(57) ABSTRACT

Provided are an electronic device and a method for controlling the same. The electronic device comprises a communication unit for receiving electricity service charge information and a controller for outputting a control signal to control output property to output predetermined contents based on the received electricity service charge information.

This nonprovisional application claims priority under 35 U.S.C. §119(a) on Patent Application No. ______ filed in Republic of Korea on ______ the entire contents of which are hereby incorporated by reference.

### BACKGROUND

1. Field

This document relates to an electronic device having an energy saving function and a method for controlling the same.

2. Related Art

Lately, a smart grid has been receiving attention for saving energy and for efficiently using energy. If such a smart grid is commercialized, a dynamic pricing to demand response system would be introduced where an electricity service charge is changed according to demand of electricity.

Accordingly, there is a need to develop a technology for effectively controlling various electronic devices in home based on a smart grid.

### SUMMARY

An aspect of this document is to provide an electronic device for saving on an electricity rate (electricity service charge) and a method for controlling the same.

In an aspect, an electronic device comprises a communication unit for receiving per-timeslot electricity rate information; and a controller for outputting a control signal to control output attribute to output predetermined contents based on the received electricity rate information.

In another aspect, an electronic device comprises a communication unit for receiving per-timeslot electricity rate information; and a controller for providing a graphical user interface to control output attribute for outputting contents when an electricity service charge of a current time is higher than a predetermined reference value based on the received electricity rate information.

The electronic device and the method for controlling the same according to the present invention provide following advantages.

According to the embodiment of the present invention, an electricity service charge can be significantly reduced by controlling a size of contents displayed on a display unit according to an electric rage changed in real time.

According to the embodiment of the present invention, a user is allowed to actively control a size of displayed contents based on an electricity service rate. Therefore, an intention of a user can be further actively reflected in controlling an electricity service charge.

According to the embodiments of the present invention, an economic benefit can be provided to a user and it is possible to contribute to the protection of environment by minimizing power consumption for watching broadcasting programs.

### BRIEF DESCRIPTION OF THE DRAWINGS

The implementation of this document will be described in detail with reference to the following drawings in which like numerals refer to like elements.

FIG. 1 is a schematic diagram that illustrates a smart grid.

FIG. 2 is a diagram that illustrates a power management network 10 in home that is a major consumer of a smart grid.

FIG. 3 is a block diagram of a power management network 10 and a digital television (DTV) 100 connected to the power management network 10.

FIG. 4 is a block diagram of a DTV 100 in connection with smart grid information and broadcasting contents.

FIG. 5 is a diagram that illustrates a DTV 100 and a storage 160 connected to the DTV 100.

FIG. 6 is a flowchart that illustrates a method for controlling an electronic device according to the first embodiment of the present invention.

FIGS. 7 to 10 are diagrams for describing the method for controlling an electronic device according to the first embodiment of the present invention.

FIG. 11 is a flowchart that illustrates a method for controlling an electronic device according to the second embodiment of the present invention.

FIGS. 12 to 14 are diagrams for describing the method for controlling an electronic device according to the second embodiment of the present invention.

FIG. 15 is a flowchart that illustrates a method for controlling an electronic device according to the third embodiment of the present invention.

FIGS. 16 to 17 are diagrams for describing the method for controlling an electronic device according to the third embodiment of the present invention.

FIG. 18 is a flowchart that illustrates a method for controlling an electronic device according to the fourth embodiment of the present invention.

FIG. 19 is a diagram for describing the method for controlling an electronic device according to the fourth embodiment of the present invention.

FIG. 20 is a flowchart that illustrates a method for controlling an electronic device according to the fifth embodiment of the present invention.

FIG. 21 is a diagram for describing the method for controlling an electronic device according to the fifth embodiment of the present invention.

FIG. 22 is a flowchart that illustrates a method for providing a preview and/or a pre-listen according to an embodiment of the present invention.

FIG. 23 is a diagram for describing the method for providing a preview and/or a pre-listen according to an embodiment of the present invention.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, there embodiments are provided so that this disclosure will be thorough and complete, and will fully convey the concept of the invention to those skilled in the art.

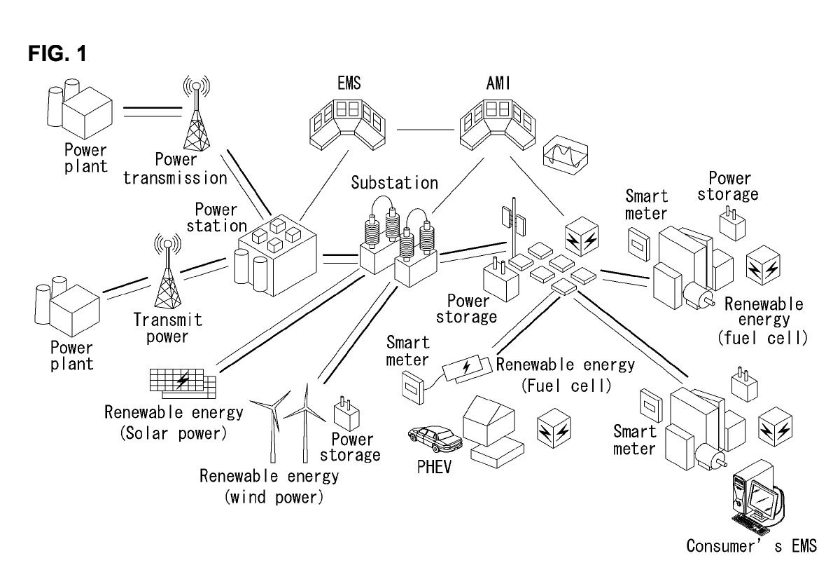

FIG. 1 is a schematic diagram that illustrates a smart grid. As shown in FIG. 1, the smart grid comprises typical power plants and renewable energy power plants. The typical power plant generates electric power using thermal power, nuclear power, and hydraulic power. The typical power plants are a thermoelectric power plant, a nuclear power plant, and a hydroelectric power plant. The renewable energy power plant generates electric power using a renewable energy such as a solar power and a wind power. For example, the renewable energy power plants are a solar power plant and a wind power plant.

The thermoelectric power plant, the nuclear power plant, or the hydroelectric power plant transmits electric power to a power station through a power line. The power station transmits the electric power to a substation, and the substation distributes the electric power to consumers such as homes and offices.

The renewable energy plant also transmits electric power to a substation. The substation distributes the electric power to consumers such as offices and homes.

Home using a home area network (HAN) may generate electric power using a fuel cell that is equipped in a Plug in Hybrid Electric Vehicle (PHEV). Such home may sell remaining electric power to others.

A smart metering device may be equipped at home and office. Using the smart metering device, it is possible to detect an electric power usage and an electricity service charge thereof in real time. Accordingly, a user may be aware of a current electric power usage and an estimated electricity service charge using the smart metering device. The user may make a plan to reduce an electric power usage and an electricity service rate thereof based on the current electric power usage and electricity service rate

Meanwhile, the power plant, the power station, and consumers can communicate with each others. Accordingly, the electric power can be generated and distributed based on the demand of the consumers by informing the power plant, the power station, and the power storage of consumers' status.

The smart grid further comprises an energy management system (EMS) and an advanced metering infrastructure (AMI). The EMS manages electric power in a consumer and estimates electric power usage in real time, and the AMI measures electric power usage at a consumer in real time.

The metering device of the smart grid employs an open architecture in order to encourage a user to effective use the electric power and to enable an electric power provider for effectively operating the system through detecting problems of the systems.

Unlike a typical communication network, the open architecture of the smart grid enables any electronic devices to be connected to the smart grid regardless of manufacturers thereof.

Therefore, the metering device used in the smart grid enables a consumer friendly efficiency concept such as “Prices to Devices”

That is, the EMS is provided in each home and broadcasts an electricity service charge (electricity rate) signal of an electricity service market in real time. The EMS communicates with electronic devices and controls the electronic devices. Accordingly, a user can monitor electricity usage information of each electronic device through the EMS and control and restrict an electricity usage amount and an electricity service charge (electricity rate) of each electronic device based on the monitored electricity usage information, thereby saving on energy and cost thereof.

The energy management system (EMS) may comprise a local energy management system and a central energy management system. The local energy management system is equipped in home or office. The central energy management system communicates with the local energy management system and collects information from the local energy management system.

Since an electricity service provider and consumers communicate with each other in real time, the electricity service provider can collect information about the electricity power usage from the consumers in real time. Therefore, the electricity service provider can reduce a high cost to prepare an electricity service for the peak demand.

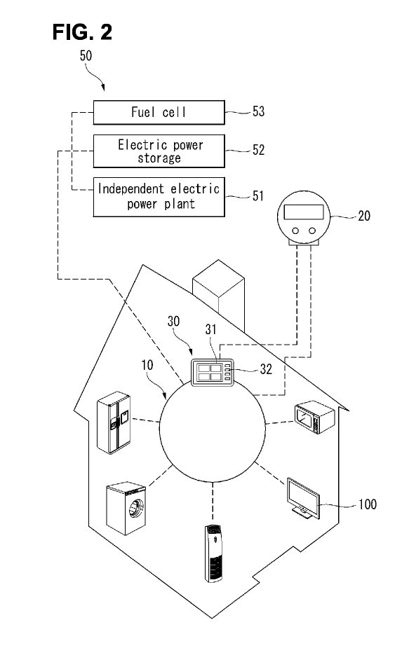

FIG. 2 is a diagram that illustrates a power management network 10 of home. Here, the home may be a major consumer in a smart grid.

The power management network 10 comprises a smart meter 20 and an energy management system 30. The smart meter 20 is a metering device that measures an electricity usage and an electricity service charge (electricity rate) thereof in real time.

The electricity service charge (electricity rate) may be charged based on a time period. The electricity service charge (electricity rate) may be increased at a peak time where an electricity power consuming rate is high. The electricity service charge (electricity rate) may be decreased at a night time whether an electricity consuming rate is low.

Here, the energy management system (EMS) 30 may comprise a display unit 31 and an input button 32. The display unit 31 displays a current electricity usage state and external environmental factors such as temperature and humidity. The input button 32 enables a user to input information into the energy management system 30. The EMS 30 may be provided as a form of a terminal.

The EMS 30 or the smart meter 20 may be connected to electronic devices such as a digital television 100 (DTV), a refrigerator, a washing machine, a dryer, an air conditioner, a cooking device, and/or a lighting device. The EMS 30 and the smart meter 20 can bi-directionally communicate with the electronic devices. That is, the EMS 30 manages electronic power consumed by the electronic devices included in the power management network 10 or supplies electric power to the electronic devices in the power management network 10. The EMS 30 may control operation of the electronic devices.

The EMS 30 or the smart meter 20 can communicate with the electronic devices through a wireless link or a wired link such as a power line communication (PLC). Each electronic device may be arranged to be connected to other electronic device to communicate with each other.

The power management network 10 may comprise a supplemental power supply 50 located at home, an independent electric power plant 51 such as a solar power plant, and an electric power storage 52 for storing electric power generated from the independent electric power plant 51.

Beside the electric power storage 52, a fuel cell 53 may be connected to the power management network 10 as a supplemental power supply.

The supplemental power supply 50 supplies electric power to home when the electric power is not supplied from an external power supply such as an electricity service providing company.

The amount of electric power supplied from the supplemental power supply or the amount of electric power stored in the supplemental power supply may be displayed on the EMS 30 or the smart meter 20.

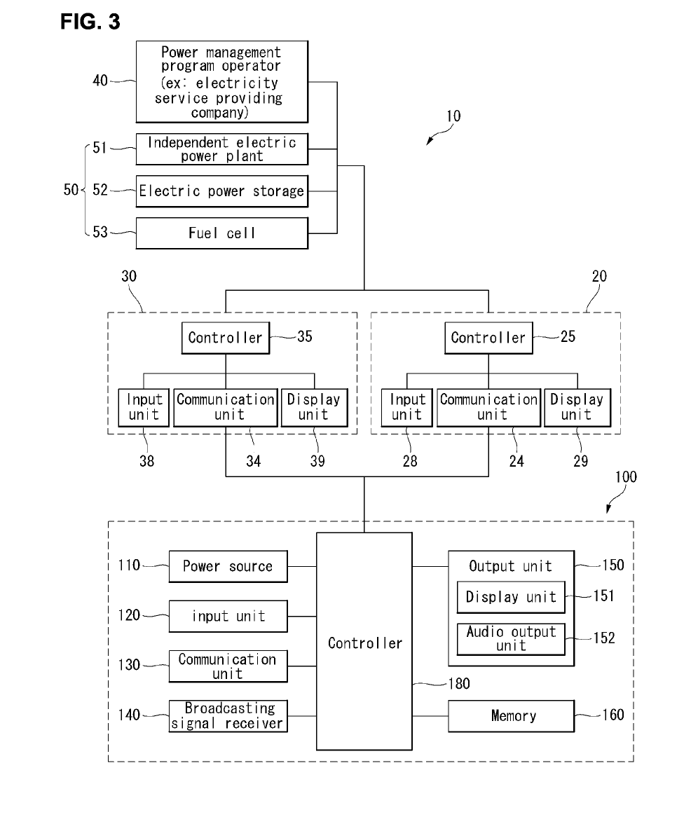

FIG. 3 is a block diagram that illustrates a power management network 10 and a digital television 100 connected to the power management network 10.

Here, a power management program operator 40 may be an electricity service providing company that has a typical power plant or a renewable power plant. However, the present invention is not limited thereto.

The power management program operator 40 not only supplies electricity but also provide information related to an electricity service charge rate to each home. Accordingly, a user may make a plan to save the electricity service charge (electricity rate) according to the electricity service charge rate.

Also, the power management program operator 40 advices a user to effectively consume an electric power by providing a guide to a user for saving on the electricity service charge (electricity rate) or by setting up a peak time where an electricity service charge (electricity rate) is very high. Hereinafter, a power supply source of the power management program operator 40 may be referred as an external power source.

The peak time is a time period where an electricity service charge (electricity rate) becomes significantly increased compared to other time period due to a high electricity consuming rate.

The power management network 10 includes a supplemental power source such as an independent power plant 51, an electric power storage 52, and a fuel cell 53.

Here, the supplemental power source 50 is different from the external power source. The supplemental power source 50 supplies electric power to home independently from the external power source. The supplemental power source 50 and the external power source are connected to the smart meter 20 and the EMS 30 and communicate with the smart meter 20 and the EMS 30. The smart meter 20 and the EMS 30 also communicate with the electronic devices. Therefore, the electronic devices may be designed to include a power source unit for receiving electric power from the external power source and/or the supplemental power source.

The EMS 30 comprises a controller 35, an input unit 38, a communication unit 34, and a display unit 39. The smart meter 20 also comprises a controller 25, an input unit 28, a communication unit 24, and a display unit 29.

The EMS 30 or the smart meter 20 is connected to the DTV 100 and communicates with the DTV 100. In order to communicate, the DTV 100 includes a communicate unit 130 for communicating with the communication unit 34 of the EMS 30 or the communication unit 24 of the metering unit 24.

The communication unit 130 of the DTV 100 receives electricity information from the EMS 30 or the smart meter 20. The electricity information includes information on an electricity service charge rate that is changed in real time.

Referring to FIG. 3, the DTV 100 comprises a power source 110, an input unit 120, a broadcasting signal receiver 140, an output unit 150, a memory 160, and a controller 180 as well as the communication unit 130.

The power source 110 receives the electric power from the external power source and/or the supplemental power source and provides the electric power to constituent elements of the DTV 100.

The input unit 120 receives inputs from a user to control the DTV 100.

As described above, the communication unit 130 receives smart grid information. The smart grid information includes the electricity service charge information (electricity rate information) and demand response (DR) information. Further, the communication unit 130 may include at least one of modules for communicating with the DTV 100 and a network such as Internet.

The communication unit 130 may receive the smart grid information through a wired link such as an Ethernet or a PLC and a wireless link such as Zigbee.

The smart grid information includes electricity service charge (electricity rate) information and/or demand response (DR) information. The smart grid information may be collected from various sources, and the smart grid information may be transmitted and received using various communication schemes.

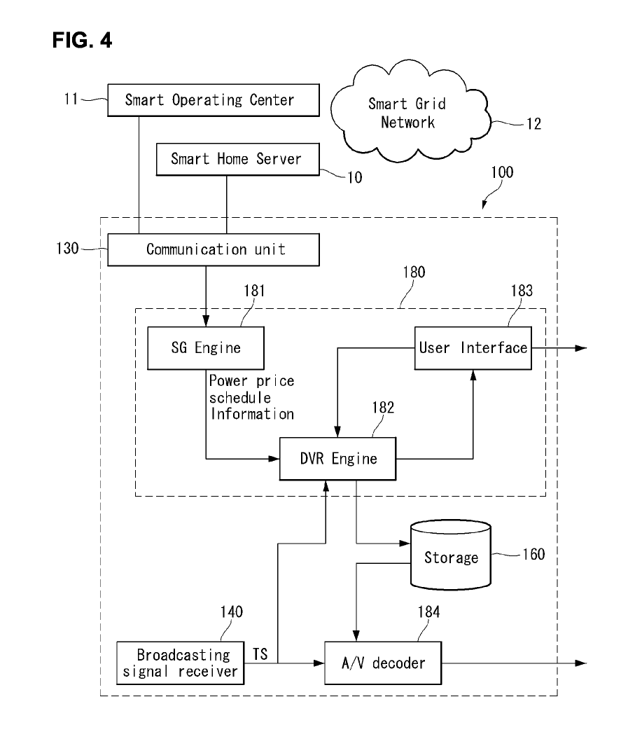

For example, the communication unit 130 may receive the smart grid information from a smart operating center 11 of FIG. 4 or a predetermined server in a smart grid network 12 or an external network.

For example, the communication unit 130 may receive the smart grid information through various communication protocols such as a wired internet, a wireless internet, a mobile internet, and a mobile communication network.

The DTV 100 may not comprise the communication unit 130. The communication unit 130 may be provided as an external device independent from the DTV 100. The communication unit 130 may communicate with the DTV 100 through a wired/wireless link. The controller 180 may process data received through the communication unit 130. For example, the communication unit 130 may be included in a set-top box connected to the DTV 100. In this case, the DTV 100 may be connected to the set-top box through an interface unit (not shown) for transmitting and receiving data.

The broadcasting signal receiver 140 receives a broadcasting signal and/or information on broadcasting from a broadcasting management server through a broadcasting channel.

The broadcasting channel may include a satellite channel and/or a terrestrial channel. The broadcasting management server may be a server that generates and transmits the broadcasting signal and/or the broadcasting information. The broadcasting server may be a server that receives previously generated broadcasting signal and/or broadcasting information and transmits the received signal and information to a terminal such as the DTV 100. The broadcasting signal may include a TV broadcasting signal, a radio broadcasting signal, and a data broadcasting signal. The broadcasting signal may be a combined broadcasting signal that is combined with a TV broadcasting signal, a radio broadcasting signal, and a data broadcasting signal.

The broadcasting information may be information on a broadcasting channel, a broadcasting program, and a broadcasting service provider.

For example, the broadcasting information may be an electronic program guide (EPG) or an electronic service guide (ESG).

The broadcasting signal receiver 140 receives a broadcasting signal using various broadcasting systems. The broadcasting signal receiver may be configured to receive a broadcasting signal from various broadcasting systems such as a digital broadcasting system.

The DTV 100 may not comprise the broadcasting signal receiver 140. In this case, the broadcasting signal receiver 140 may be provided as an external device independent from the DTV 100. The broadcasting signal receiver 140 may communicate with the DTV 100 through a wired/wireless link. The controller 180 may process data received through the broadcasting signal receiver 140. For example, the broadcasting signal receiver 130 may be included in a set-top box (not shown) connected to the DTV 100.

After the broadcasting signal receiver 140 receives the broadcasting signal and the broadcasting information, the broadcasting signal and/or the broadcasting information may be stored in the memory 160.

The output unit 150 outputs visual output, auditory output, and haptic output. The output unit 150 may comprise a display unit 151 and an audio output unit 152. The output unit 150 may further comprise a haptic module 154 for generating haptic output, such as vibration.

The display unit 150 displays information processed by the DTV 100.

The display unit 151 may include at least one of a liquid crystal display, a thin film transistor-liquid crystal display, an organic light-emitting diode, a flexible display, and a 3D display.

The DTV 100 may comprise more than two display units 151 according to the design thereof.

Meanwhile, the DTV 100 may not include the display unit 151. In this case, the display unit 151 may be realized as an external device independent from the DTV 100. The controller 180 may control the display unit 151 through a wired/wireless link.

When the display unit 151 is realized as an external device independent from the DTV 100, the display unit 151 and the DTV 100 may or may not share a power supply source.

The audio output unit 152 outputs an audio signal received from an external device or generated by the DTV 100. That is, the audio output unit 152 outputs an audio signal related to a function performed by the DTV 100.

The audio output unit 152 may include a speaker and a buzzer. The audio output unit 152 may output sound through an ear phone jack. A user may listen sound by connecting an ear phone to the ear phone jack.

The memory 160 temporally or permanently stores programs for operations of the controller 180 and input/output data such as an audio signal, a still image, a moving image, and broadcasting information.

The memory 160 may comprise at least one of a flash memory, a hard disk, a multimedia card micro type memory, a card type memory such as a SD or XD memory, a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

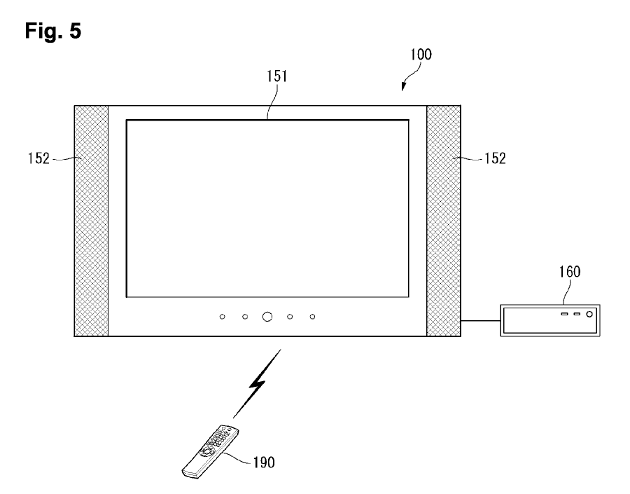

The memory 160 may be realized as an external device independent from the DTV 100 as shown in FIG. 5. For example, a digital video recorder (DVR) may be realized as an external device independent from the DTV 100 while performing the roll of the memory 160.

The memory 160 may be referred as a storage device.

The DTV 100 may cooperate with a web storage that performs a same storage function of the memory 160 on the internet.

The controller 180 controls general operation of the DTV 100. For example, the controller 180 controls operations for receiving a broadcasting signal, recording a broadcasting signal, and accessing the Internet.

The controller 180 may comprise a multimedia module for reproducing multimedia data. The multimedia module may be included in the controller 180 or may be realized as an external device independent from the controller 180. The multimedia module may include an audio/video decoder.

Embodiments of the present invention may be realized as software and/or hardware. That is, the embodiments of the present invention may be realized as a program that can be stored in a computer readable recording medium and performed by a computer.

For example, the embodiments of the present invention may be realized using at least one of application specific integrated circuits (ASIC), digital signal processors (DSP), digital signal processing devices (DSPD), programmable logic devices (PLD), field programmable gate arrays (FPGA), processors, controllers, micro-controllers, and microprocessors. In this case, a hardware configuration according to the embodiments of the present invention may be controlled by the controller 180.

For example, the embodiments of the present invention may be realized as a software module that performs at least one of functions and/or operations thereof. Software codes may be realized by a software application written in a predetermined program language. Also, the software codes may be stored in the memory 160 and performed by the controller 180.

FIG. 4 is a diagram that illustrates a DTV 100 in connection with smart grid information and broadcasting contents.

Referring to FIG. 4, the DTV 100 includes a controller 180, a smart grid engine 181, a DVR engine 182, and a UI processor 183.

The smart grid engine 181 receives the smart grid information form the communication unit 130 and processes the smart grid information to a predetermined format to be processed in the DTV 100.

As shown in FIG. 4, the communication unit 130 directly receives the smart grid information from the smart grid network 12 through the smart operating center 11 or indirectly receives the smart grid information from the smart grid network 12 through a smart home server 10.

The smart operating center 11 may be an EMS located outside home, and the smart home server 10 may be the power management network 10.

The DVR engine 182 performs operations for storing broadcasting contents. For example, the DVR engine 182 calculates information necessary for storing the broadcasting contents.

For example, the DVR engine 182 receives broadcasting contents requested by the UI processor 183. The DVR engine 182 receives the requested broadcasting contents in a form of a transport stream (TS) through the broadcasting receiver 140 and stores the received broadcasting contents in the storage 160.

For example, the DVR engine 182 calculates an optimal time of watching the broadcasting contents stored in the storage 160 using the smart grid information processed and stored by the smart grid engine 181. The DVR engine 182 informs a user of the calculated optimal time.

The UI processor 183 generates, stores, and outputs various user interfaces (UI) that will be described in later. The UI processor 183 process user inputs received through the user interface (UI).

The DTV 100 may comprise an A/V decoder 184. The A/V decoder 184 may be included in the controller 180 or realized as an external device independent from the controller 180.

The A/V decoder 184 decodes the transport stream received through the broadcasting signal receiver 140 and outputs the decoded transport stream. The A/V decoder 184 may decode the broadcasting contents stored in the storage 160 and output the decoded broadcasting contents.

The embodiments of the present invention were described using a digital television (DTV) as an example. Also, the DTV was described to include the above described constituent elements. However, the DTV may exclude one of the described constituent elements. The excluded elements may be included in an additional independent device such as a set-top box. In this case, it is obvious to those skilled in the art that the DTV and the set-top box communicate with each other to archive the object of the present invention.

Furthermore, the DTV 100 was described as an example of electronic devices in home. However, the present invention is not limited thereto. Hereinafter, various embodiments of the present invention will be described using the DTV 100 as an example of electronic devices.

FIG. 5 is a diagram illustrating a DTV 100 and a storage device 160 connected to the DTV 100. As described above, the storage device 160 performs a roll of the memory 160 and may be an external device independent from the DTV 100.

As shown in FIG. 5, a user may control the DTV using a remote controller 190.

Although FIG. 5 describes that a user uses the remote controller 190 to control an electronic device such as the DTV 100, a user may control the electronic device without the remote controller 190. For example, a user may control the electronic device by making a predetermined motion, a predetermined gesture, and a predetermined sound without the remote controller 190. Since a controlling scheme without using the remote controller 190 is not directly related to the object of the present invention, the detailed descriptions thereof are omitted herein.

In the embodiments of the present invention, an electricity service charge (electricity rate) may be reduced by properly controlling an output property (output attribute) for outputting contents based on electricity service charge information (electricity rate information) and demand response information included in the received smart grid information. Hereinafter, a method for controlling output property (output attribute) for outputting contents based on to the smart grid information according to embodiments of the present invention will be described.

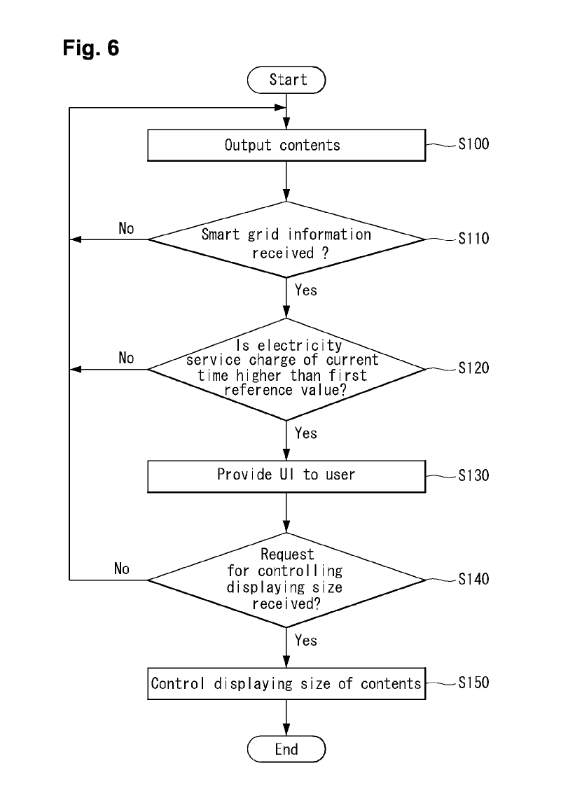

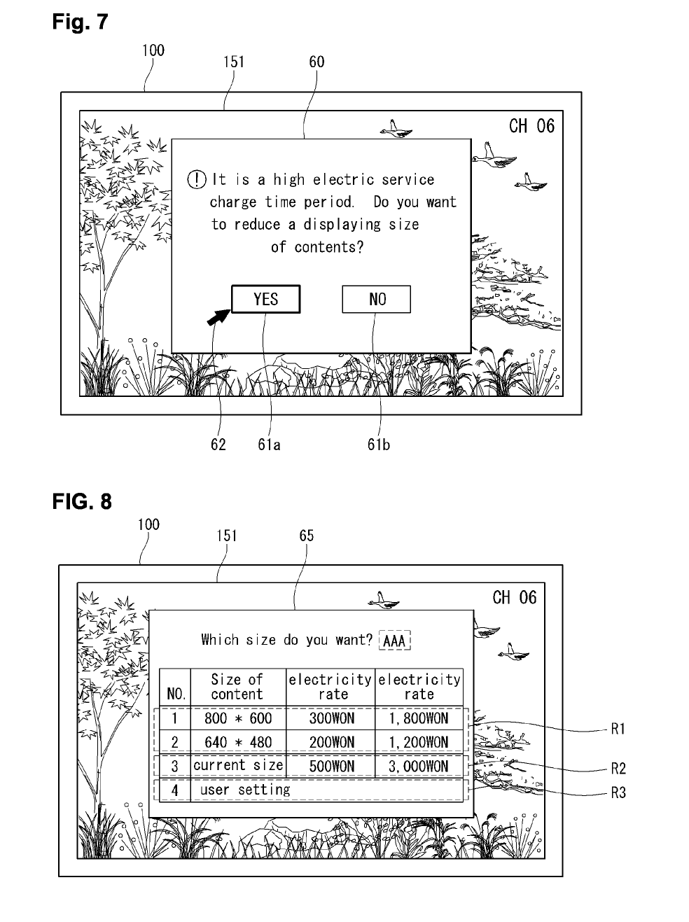

FIG. 6 is a flowchart that illustrates a method for controlling an electronic device according to the first embodiment of the present invention. FIGS. 7 to 10 are diagrams for describing the method for controlling an electronic device according to the first embodiment of the present invention.

The method for controlling an electronic device according to the first embodiment of the present invention can be realized in the environments and the DTV 100 shown in FIGS. 1 to 5. The method for controlling an electronic device according to the first embodiment of the present invention will be described with reference to FIGS. 1 to 6.

Referring to FIG. 6, the controller 180 decodes broadcasting contents received through the broadcasting signal receiver 140 using the A/V decoder 184 and outputs the decoded broadcasting contents through the output unit 150 at step S100. For example, a user may watch broadcasting contents that is broadcasted in real time in the step S100. The displayed broadcasting contents may be not broadcasting contents that are broadcasted in real time. The controller 180 may display broadcasting contents stored in the memory 160 of the DTV 100 or broadcasting contents stored in the storage device 160. Hereinafter, the displayed broadcasting contents denote not only broadcasting contents that are broadcasted in real time but also broadcasting contents stored in the memory 160 or the storage device 160 for convenience.

The controller 180 determines whether the communication unit 130 receives smart grid information or not at step S110. The smart grid information may include per-timeslot electricity rate information. The per-timeslot electricity rate means that an electricity rate for a first specific time period may be different from an electricity rate for a second specific time period different from the first specific time period. As described above, the smart grid information may be stored in the storage device or the memory 160.

The controller 180 may perform the step S100 again when the controller 180 determines that smart grid information is not received at step S110.

When the controller 180 determines that the smart grid information is received at step S110, the controller 180 determines whether a current electricity service charge (electricity rate) is higher than a first reference value or not at step S120.

The smart grid information may include electricity service charge rates according to time periods as described above. Accordingly, the controller 180 determines whether an electricity service charge rate of a current time period is higher than the first reference value or not based on the received smart grid information.

The first reference value may be an electricity service charge (electricity rate) corresponding to the peak time period. For example, the first reference value may be a reference value that is set corresponding to a highest electricity service charge (electricity rate). The first reference value may be a value that is set corresponding to the highest electricity demanding period such as a peak time period.

The first reference value may be calculated or set based on statistical analysis of electricity service charges in predetermined time periods. Here, the electricity service charge information is included in the smart grid information received from the smart grid network 12.

For example, the controller 180 can obtain information about the highest electricity service charge (electricity rate) by analyzing electricity service charge information (electricity rate information) of predetermined time periods, which is included in the smart grid information. The first reference value may be decided based on the obtained highest electricity service charge (electricity rate). Here, the first reference value may be equal to or smaller than the highest electricity service charge (electricity rate). For example, the first reference value may be about 80% of the highest electricity service charge (electricity rate).

The controller 180 may be updated the first reference value regularly or not regularly. For example, the controller 180 updates the first reference value at every month, at every three months, or at every six months.

The controller 180 may perform the step S100 again when the controller 180 determines that electricity service charge (electricity rate) of the current time is smaller than the first reference value at step S120.

At step S130, the controller 180 provides a user interface for controlling a displaying size of contents displayed on the display unit 151 when the controller 180 determines that the electricity service charge (electricity rate) of the current time is higher than the first reference value at the step S120.

That is, the user interface for controlling the displaying size is a user interface that asks and confirms a user to control the displaying size of contents or which displaying size that a user wants to change a current displaying size to.

FIG. 7 is a diagram that illustrates a user interface 60 for controlling a displaying size of broadcasting contents.

Referring to FIG. 7, the controller 180 may display the user interface 60 on a display unit when the electricity service charge (electricity rate) is higher than the first reference value.

The user interface 60 may provide a YES icon 61a and an NO icon 61b.

The user may use the remote controller 190 to select one of the icons 61a and 61b.

For example, a user moves a cursor 62 displayed on the display unit 151 to one of the icons 61a and 61b by controlling the remote controller 190 and selects the one of the icons 61a and 61b by clicking a key of the remote controller 190.

For example, a user may select one of the icons 61a and 61b by clicking one of keys set corresponding to the icons 61a and 61b among various buttons of the remote controller 190. The user may select one of the icons 61a and 61b through user motion, gesture, and voice of the user beside of using the remote controller 190.

At step S140, the controller 180 determines whether the user wants to control a displaying size of broadcasting contents through the user interface 60 or not.

The controller 180 may return to the step S100 when the user denies changing the displaying size of contents by selecting the NO icon.

When the controller 180 receives a request of controlling a size of displayed broadcasting contents from a user through the user interface 60, the controller 180 can control the output unit 150 to reduce or to increase the displaying size of broadcasting contents to a target size at step S150. For example, the displaying size of broadcasting contents can be controlled by controlling a resolution of displaying the broadcasting contents on the display unit 151.

The displaying size of broadcasting contents may be decided based on a reference value that is previously decided according to smart grid information received through the communication unit 130. For example, a reference value is previously decided based on electricity service charge rates of time periods included in the smart grid information, and the displaying size of broadcasting contents may be decided based on the previously decided reference value without user selection to a displaying size of contents.

The controller 180 may reduce a displaying size of broadcasting contents based on the smart grid information when the current electricity service charge (electricity rate) is higher than the predetermined reference value. For example, when the current electricity service charge (electricity rate) is higher than the first reference value, the displaying size of broadcasting contents may be reduced.

Furthermore, a plurality of reference values may be provided. A displaying size of broadcasting contents may be set differently corresponding to the plurality of reference values. For example, the displaying size of broadcasting contents may be reduced as the reference value increases. Accordingly, a user may save on an electricity service charge (electricity rate) while watching desired broadcasting contents at a time period of an expensive electricity service charge (electricity rate).

When the displaying size of broadcasting contents is automatically controlled without user selection to the displaying size, the controller 180 may ask a user whether to continuously watch the broadcasting contents with the automatically controlled displaying size and receive a user response at the same time of displaying the broadcasting contents with the controlled size.

Meanwhile, the controller 180 may receive a desired displaying size from the user through the user interface 60 at the same time of providing the user interface 60 to the user or when the controller 180 receives a request of controlling the displaying size of contents.

For example, the controller 180 may display an information window 65 on the display unit 151 in order to show a current displaying size of contents and an estimated electricity service charge thereof.

The information window 65 further includes an information area 66 that shows controllable displaying sizes of contents, corresponding unit electricity service charges, and total estimated electricity service charge of watching the contents.

The information area 66 may display recommended displaying sizes of contents, corresponding unit electricity service charges, and total estimated electricity service charge for watching predetermined contents as shown in a block R1. The information area 66 may provide information on a unit electricity service charge of a current displaying size of the contents and a total estimated electricity service charge for watching the contents as shown in a block R2.

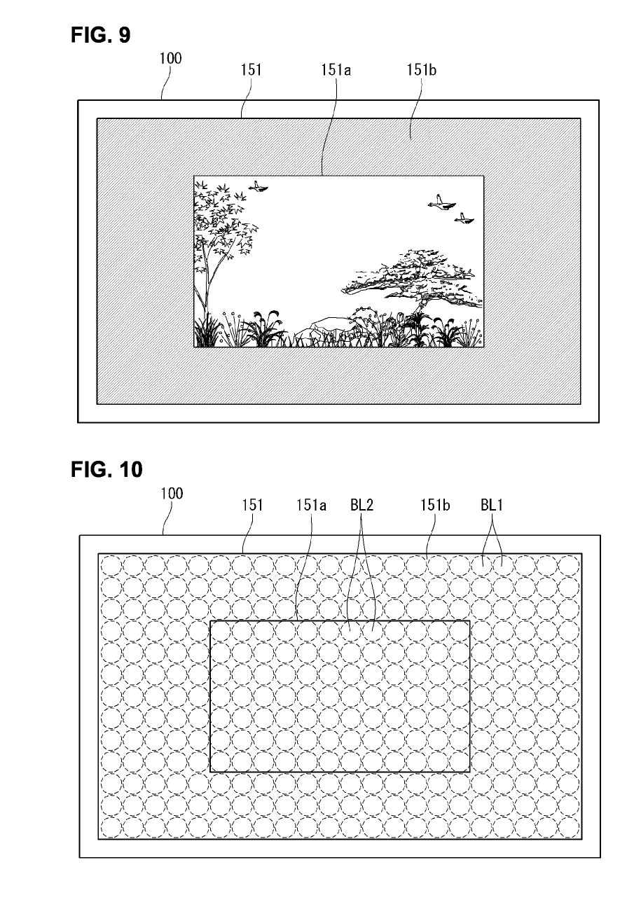

The information area 66 may includes an item R3 to enable a user to directly select a displaying size of contents. When a user selects the item R3 using the remote controller 190, the user may directly input a desired displaying size of contents using a key pad of the remote controller 190. Or, the user may control a displaying size of contents through a predetermined interface such as a drag & drop. As shown in FIG. 9, the information area 66 further displays a unit electricity service charge of a controlled displaying size and a total estimated electricity service charge thereof on the display unit 151.

The displaying sizes of contents in the information window 65 may be provided as resolutions as shown in FIG. 8. Differently, the displaying sizes of contents may be a ratio of an original displaying size and a controlled displaying size. For example, the displaying sizes may be provided as about “80%” or about “60%” of the original size.

Although it is not shown, the information area 66 may further provide an electric service charge rate between an electricity service charge for a current displaying size and an electricity service charge for a controlled displaying size. Accordingly, a user can be easily aware of how much electricity service charge will be increased or decreased by controlling a displaying size of contents.

As shown in FIGS. 7 and 8, a user can request controlling a displaying size of contents through the user interface 60 or the information window 65. For example, when a user requests reducing a displaying size of contents as shown in FIG. 9, the broadcasting contents is displayed on the display unit 151 with the reduced displaying size. Hereinafter, a contents displaying area 151a denotes a reduced displaying size of contents.

Although it is not shown, the controller 180 may provide position information in order to allow a user to select a position of displaying contents with a reduced displaying size on the display unit 151 when the user reduces the displaying size of contents. The position information may be set as a default value. For example, the position information may be a center position, a left bottom position, and a right top position. Unlikely, the controller 180 may provide an additional user interface for asking a user to confirm the contents displaying area 151a. For example, the additional user interface may be a Drag & Drop user interface for receiving a displaying position from the user.

As shown in FIGS. 9 and 10, broadcasting contents may be displayed only on the content displaying area (CA) in the entire display unit 151. Backlights (BL1) of not-selected displaying area may be turned off while backlights BL2 are continuously turned on at the contents displaying area 151a.

Accordingly, electric power consumed by backlights can be saved. For example, a display module including backlights consumes the most of electric power consumed in a DTV or an electronic device having a large sized display module. According to the first embodiment, the power consumption of the electronic device can be significantly reduced by controlling a displaying size of contents. That is, electric power is supplied only to backlights of the contents displaying area 151a, thereby significantly reducing the power consumption.

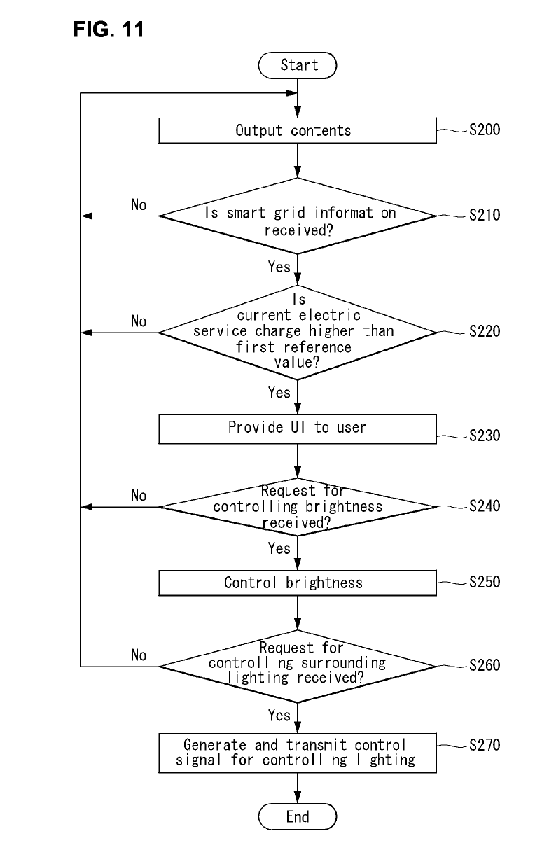

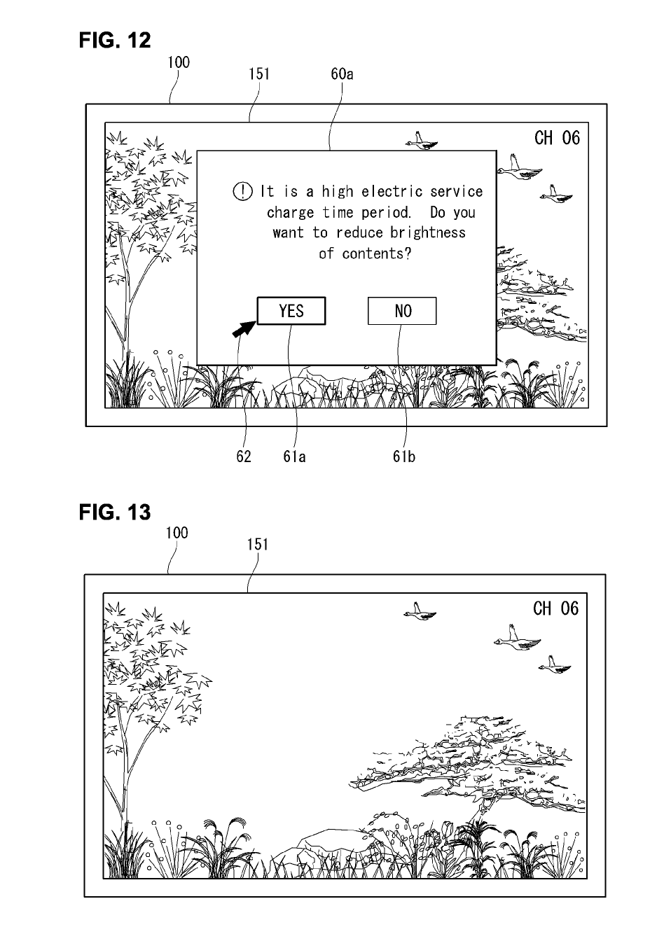

FIG. 11 is a flowchart that illustrates a method for controlling an electronic device according to the second embodiment of the present invention. FIGS. 12 to 14 are diagrams for describing the method for controlling an electronic device according to the second embodiment of the present invention.

The method for controlling an electronic device according to the second embodiment may be realized in the environments and a digital TV (DTV) 100 which are shown in FIGS. 1 to 5. Hereinafter, the method for controlling an electronic device according to the second embodiment of the present invention will be described using the DTV 100 as an example.

Referring to FIG. 11, the DTV 100 displays contents at step S200, determines whether smart grid information is received or not at step S210, and determines the electricity service charge of a current time is higher than a first reference value or not at step S220. Since the steps S200, S210, and S220 are identical to those of the controlling method according to the first embodiment of FIG. 6, the detailed descriptions thereof are omitted herein.

At step S220, the controller 180 may provide a user interface 60a as shown in FIG. 12 through the display unit 151 when the electricity service charge of the current time is higher than the first reference value.

As shown in FIG. 12, the user interface 60a is to control brightness of the display unit 151 for displaying current broadcasting contents. That is, the user interface 60a asks a user whether the brightness of displayed contents is controlled or not, or which brightness level the user wants to change a current brightness level to. Since other functions of the user interface 60a are identical to those of the user interface 60 according to the first embodiment of the present invention, the detailed descriptions thereof are omitted herein.

At step S240, the controller 180 determines whether a user requests controlling brightness of displaying broadcasting contents through the user interface 60a like the first embodiment.

When the user denies controlling the brightness of displaying broadcasting contents through the user interface 60a, the controller 180 performs the step S200 again.

At step S250, the controller 180 may control the output unit 150 to increase or decrease the brightness of the display unit 151 for displaying the contents when the controller 180 receives a request of controlling brightness of contents.

The brightness of displaying broadcasting contents may be decided according to a predetermined brightness reference value based on the smart grid information received through the communication unit 130. That is, the brightness of displaying broadcasting contents may be decided based on unit electricity service charges of time periods without user selection to the brightness.

The controller 180 may reduce the brightness of displaying broadcasting contents based on the smart grid information when a current electricity service charge is higher than a predetermined reference value. That is, the broadcasting contents may be displayed with less brightness. For example, when the electricity service charge is higher than the first reference value, the brightness of displaying broadcasting contents may be reduced as shown in FIG. 13.

The controller 180 may control brightness of backlights included in the display unit 151 in order to control of displaying broadcasting contents.

A plurality of reference values may be used to control the brightness of displaying broadcasting contents. For example, the brightness of displaying broadcasting contents may be reduced as the reference value increases. Accordingly, a user can reduce an electricity service charge while watching desired broadcasting contents even in a time period of a high electricity service charge.

The controller 180 can determine whether brightness of displaying broadcasting contents on the display unit 151 in consideration of the illumination intensity of surrounding environments around the DTV 100. That is, controller 180 receives illumination intensity information from an illumination intensity meter (not shown) included in the DTV 100. The controller 180 determines whether or not a user has difficulty to watch contents under the current illumination intensity while the contents are displayed in the current illumination intensity of the surrounding environment.

When the controller 180 determines that the user has difficulty to watch contents, the controller 180 may provide a user interface for asking a user to control the current brightness of displaying contents and for allowing a user to choose a desired bright level.

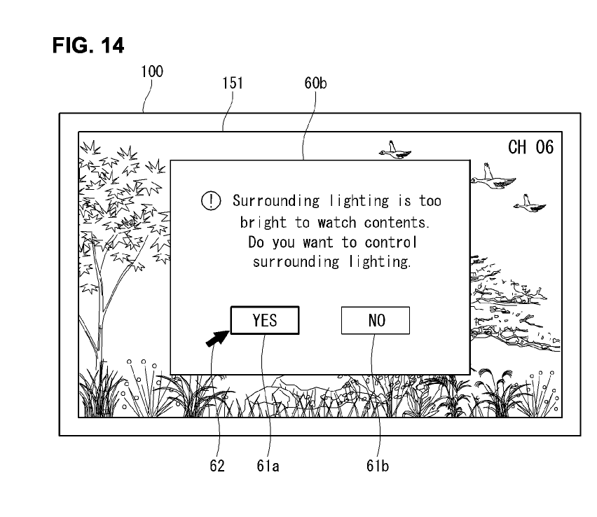

FIG. 14 is a diagram that illustrates a user interface 60b displayed on a display unit 151. The user interface 60b is to control surrounding lighting.

At step S260, the controller 180 determines whether a user requests controlling surrounding lighting through the user interface 60b.

When the user denies controlling surrounding lighting through the user interface 60b, the controller 180 may perform the step S200 again.

When a user requests controlling surrounding lighting through the user interface 60d, the controller 180 may generate a control signal to control surrounding lighting at step S270.

At step S270, the controller 180 may transmit the control signal to the energy management system 30 of the power management network 10 and/or a power management server (not shown) managing the power management network 10. The energy management apparatus 30 controls surrounding lighting by controlling lighting devices and light shielding devices around the DTV 100 according to the control signal. The controller 180 may transmit a control signal directly to the lighting devices and the light shielding devices through the power management network 10.

For example, when the controller 180 determines that a user has difficulty to watch contents because surrounding illumination intensity is too bright and the brightness of displaying the contents is too dark, a control signal for controlling surrounding lighting is created and transmitted from the DTV 100. The energy management system 30 receives the control signal, and surrounding illumination intensity may be reduced by reducing the brightness of lighting devices or by blocking light that enters from the outside to the inside through controlling a light shielding device such as curtains.

The electricity service charge can be reduced by properly controlling the brightness of the electronic device such as the DTV 100 according to the second embodiment of the present invention. Furthermore, surrounding illumination intensity is dynamically controlled according to the second embodiment of the present invention. Accordingly, an overall electric service charge can be reduced while eliminating user's difficulty to watch contents by controlling the brightness.

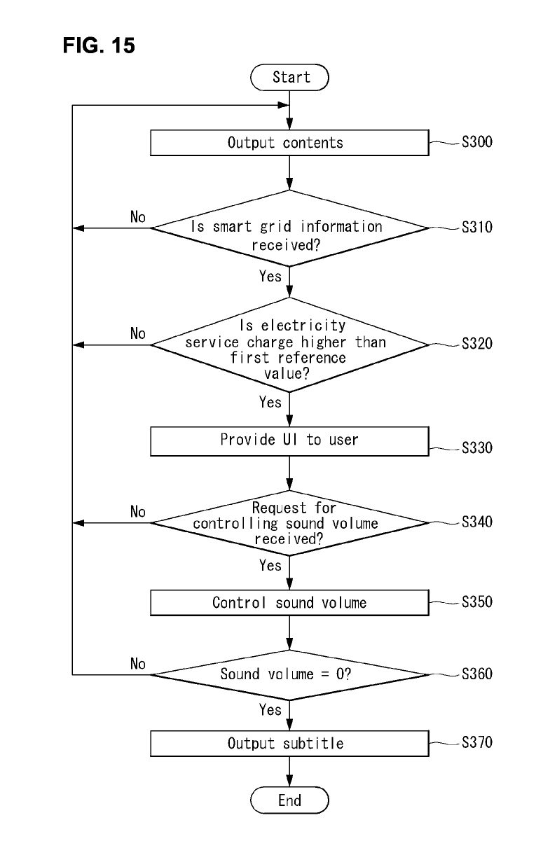

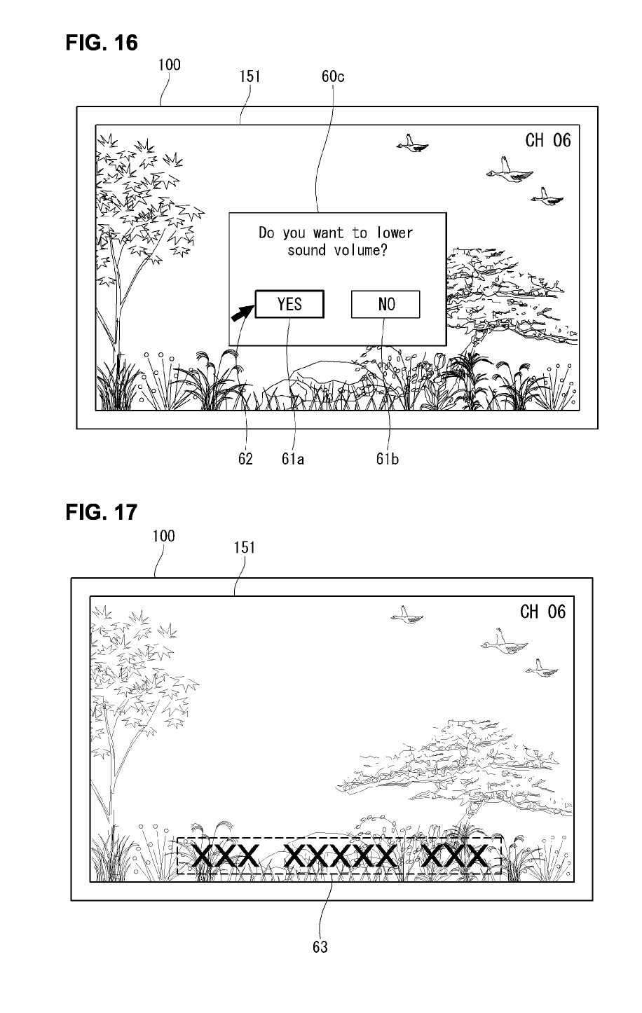

FIG. 15 is a diagram that illustrates a method for controlling an electronic device according to the third embodiment of the present invention. FIGS. 16 and 17 are diagrams for describing the method for controlling an electronic device according to the third embodiment of the present invention.

The method for controlling an electronic device according to the third embodiment of the present invention can be realized in the environments and the DTV 100 shown in FIGS. 1 to 5. With reference to the accompanying drawings, the method for controlling an electronic device according to the third embodiment of the present invention will be described using the DTV 100 as an example.

Referring to FIG. 15, the display device 100 outputs contents at step S300, determines whether smart grid information is received or not at step S310, and determines an electricity service charge of a current time period is higher than a first reference electricity service charge at step S320. Since the steps S300, S310, and S320 are identical to those of the first embodiment of FIG. 6, the detailed descriptions thereof are omitted herein.

When the electricity service charge of the current time is higher than the first reference value at step S320, the controller 180 provides a user interface 60c as shown in FIG. 16 at step S330.

As shown in FIG. 16, the user interface 60c is to control a sound volume of contents that a user is watching. For example, the user interface 60c asks and confirms whether a user wants to control a sound volume of contents that a user is watching and which a sound volume level a user wants to change a current sound volume level to. Since other functions of the user interface 60c are identical to those of the user interface 60 according to the first embodiment, the detailed descriptions thereof are omitted herein.

Like the first embodiment, the controller 180 determines whether a user requests controlling a sound volume of the contents through the user interface 60c at step S340.

When the user denies controlling the sound volume through the user interface 60c, the controller 180 performs the step S300 again.

When the user requests controlling the sound volume through the user interface 60c, the controller 180 controls the output unit 150 to increase or decrease a sound volume of contents that is output through the audio output unit 152 at step S350.

The sound volume of the contents may be decided based on a predetermined reference value by considering smart grid information received through the communication unit 130. That is, the sound volume of contents may be decided based on electricity service charge information of each time period included in the smart grid information without user selection to the sound volume.

The controller 180 may reduce the sound volume of the contents based on the smart grid information when a current electricity service charge is higher than the predetermined electricity service charge reference. For example, the controller 180 reduces the sound volume of the contents when the electricity service charge is higher than a first threshold value.

Furthermore, the controller 180 may control the sound volume based on a plurality of sound volume references. Different sound volumes may be assigned to the plurality of sound volumes respectively. For example, the sound volume is increased as the sound volume reference increases.

Power consumption increases as the sound volume outputted through the audio output unit 152 increases, and power consumption decreases as the sound volume decreases. Accordingly, a user can save an electricity service charge by dynamically controlling a sound volume based on the electricity service charge and by controlling a sound volume based on the user selection while watching contents even at a high electricity service charge time period.

The controller 180 determines whether a sound volume is 0 or not at step S360. When a sound volume selected by the controller 180 or selected by a user is 0, the controller 180 interrupts supplying electric power to the audio output unit 152. Then, the controller 180 converts information corresponding to the sound of the contents to displayable information such as subtitle 63 and texts and displays the displayable information on the display unit 151 at step S370.

According to the third embodiment, a user can save an electricity service charge by properly changing a sound volume of an electronic device, such as the DTV 100, according to an electricity service charge.

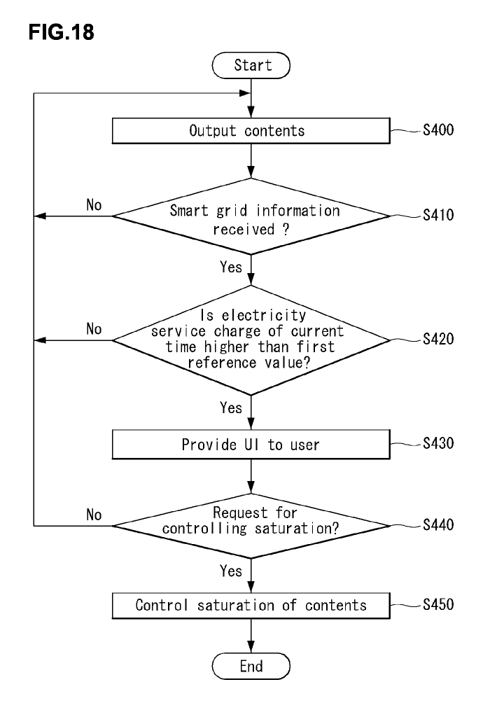

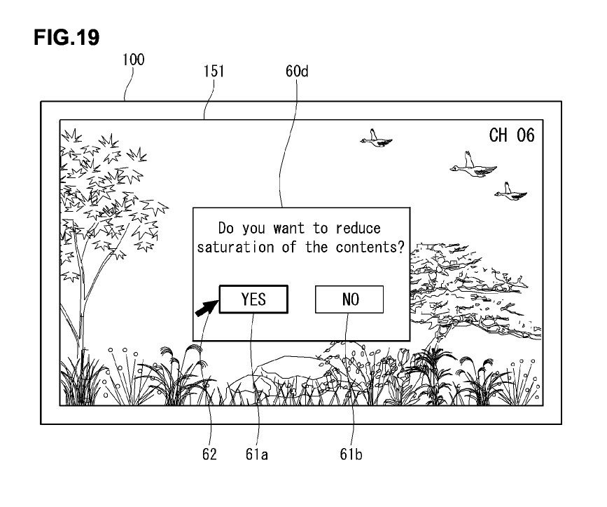

FIG. 18 is a diagram that illustrates a method for controlling an electronic device according to a fourth embodiment of the present invention. FIG. 19 is a diagram for describing the method for controlling an electronic device according to the fourth embodiment of the present invention.

The method for controlling an electronic device according to the fourth embodiment of the present invention can be realized in the environments and the DTV 100 shown in FIGS. 1 to 5. Hereinafter, the method for controlling an electronic device according to the fourth embodiment of the present invention will be described with reference to the accompanying drawings using the DTV 100 as an example of the electronic device.

Referring to FIG. 18, the DTV 100 outputs broadcasting contents at step S400, determines whether smart grid information such electricity service charge information and demand response information is received or not at step S410, and determines whether an electricity service charge of a current time is higher than a first reference electricity service charge at step S420. Since the steps S400, S410, and S420 are identical to those of the first embodiment of FIG. 6, the detailed descriptions thereof are omitted.

When the electricity service charge (or demand response) of the current time is higher than the first reference value, the controller 180 provides a user interface 60d of FIG. 19 through the display unit 151 at step S430.

As shown in FIG. 19, the user interface 60d is to control the color tone of broadcasting contents that a user is watching. The user interface 60d asks and confirms a user to control the color tone of broadcasting contents and to control the current color tone to a predetermined color tone level. Since other functions of the user interface 60d are identical to those of the user interface 60 according to the first embodiment, the detailed descriptions thereof are omitted herein.

Like the first embodiment, the controller 180 determines whether a user requests controlling the color tone of the contents or not through the user interface 60d at step S440.

When the user does not request controlling the color tone of the contents, the controller 180 performs the step S400 again.

When the user requests controlling the color tone of the contents, the controller 180 controls the output unit 150 to increase or decrease the color tone of the contents at step S450.

The color tone of the contents may be decided according to a predetermined reference value by considering smart grid information received through the communication unit 130. That is, the color tone of the contents may be decided with reference to electricity service charge information (or demand response information) of each time period included in the smart grid information based on a predetermined reference without user selection to the color tone of the contents.

The controller 180 may reduce the color tone of the contents when a current electricity service charge (or response demand) is higher than a predetermined value. For example, the color tone of the contents may be reduced when the electricity service charge (or demand response) is higher than the first reference value.

When the color tone of the contents outputted through the output unit 150 is decreased, the power consumption of the display unit 151 is reduced. For example, when the color tone of the contents is changed to ‘0’, the contents may be outputted as black/white tone. Here, electric power consumed for displaying the contents with the controlled color tone is reduced compared to electric power consumed for displaying the contents with the original color tone. Accordingly, a user can save on an electricity service charge by appropriately controlling color tone of contents actively or based on the user selection while watching the contents at the high electricity service charge time period.

According to the fourth embodiment of the present invention, a user can save on the electricity service charge by properly controlling the color tone of an electronic device having a display device 151 such as the DTV 100.

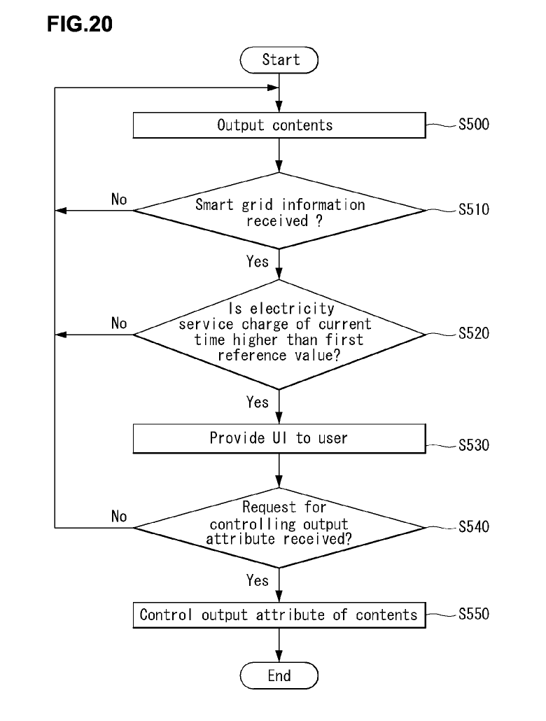

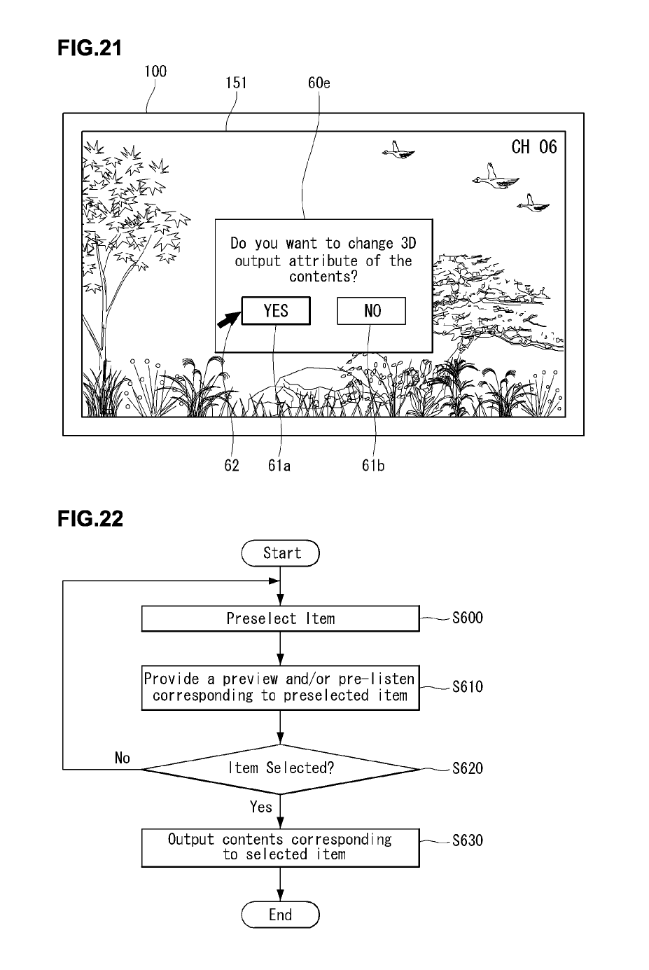

FIG. 20 is a diagram that illustrates a method for controlling an electronic device according to a fifth embodiment of the present invention. FIG. 21 is a diagram for describing the method for controlling an electronic device according to the fifth embodiment of the present invention.

The method for controlling an electronic device according to the fifth embodiment may be realized in the environments and the DTV 100 shown in FIGS. 1 to 5. Hereinafter, the method for controlling an electronic device according to the fifth embodiment will be described with reference to the accompanying drawings using the DTV 100 as an example of the electronic device.

Referring to FIG. 20, the DTV 100 outputs contents at step S500, determines whether smart grid information such as electricity service charge information or response demand information is received or not at step S510, and determines whether an electricity service charge (or response demand) of a current time is higher than a first reference value at step S520. The steps S500, S510, and S520 are identical to those of the first embodiment of FIG. 6. Accordingly, the detailed descriptions thereof are omitted herein.

When the electricity service charge (or response demand) of a current time is higher than a first reference value at step S520, the controller 180 may provide a user interface 60e of FIG. 21 through the display unit 151 at step S530.

As shown in FIG. 21, the user interface 60e is to control a current 3D output property (output attribute) of contents. For example, the user interface 60e asks a user whether to display the contents in 2D or 3D. When the user wants to display the contents in 3D, the user interface 60e asks a user how much 3D output property (output attribute) is controlled. Since other functions of the user interface 60e are identical to those of the user interface 60 according to the first embodiment, the detailed descriptions thereof are omitted herein.

Like the first embodiment, the controller 180 determines whether a user requests controlling 3D output property (output attribute) of the contents through the user interface 60e at step S540.

When the user does not request controlling 3D output property (output attribute) of the contents through the user interface 60e, the controller 180 performs the step S500 again.

When the user requests controlling 3D output property (output attribute) of contents through the user interface 60e, the controller 180 controls the output unit 150 to output contents in 3D or controls the output unit 150 to increase or decrease a depth value at step S550.

Lately, 3D contents have been receiving attention, and a 3D television has been commercialized. Furthermore, a 3D television that converts 2D contents to 3D contents also has been commercialized. In order to convert the 2D contents to 3D contents, the DTV 100 may further include a 3D conversion module (not shown). That is, the DTV 100 includes a module for additionally processing 2D contents to convert 2D contents to 3D contents. Accordingly, such additional data processing cause additional power consumption. Meanwhile, when 3D contents are displayed, a depth value and a data processing amount are changed according to a 3D effect level. For example, when 2D contents are converted to 3D contents with a high 3D effect level, high power consumption is required and a large amount of data needs to be processed. When 2D contents are converted to 3D contents with a low 3D effect level, less power consumption is required and a comparatively small amount of data needs to be processed.

A user can reduce power consumption of the electronic device by properly controlling 3D output property (output attribute) of contents according to the smart grid information such as electricity service charge information or respond demand information according to the fifth embodiment.

The 3D output property (output attribute) of the contents may be decided according to a predetermined reference value based on the smart grid information received through the communication unit 130. That is, the 3D output property (output attribute) of contents can be decided according to the predetermined reference value based on electricity service charge information (or response demand information) of each time period included in the smart grid information without user selection to the 3D output property (output attribute) of contents.

Here, when a current electricity service charge (or response demand) is higher than a predetermined reference value, the controller 180 may not convert 2D contents to 3D contents or may reduce a depth value thereof. For example, when the electricity service charge (or response demand) is higher than the first reference value, the controller 180 outputs the contents in 2D or outputs the contents in 3D with a depth value reduced.

When a depth value of contents output through the output unit 150 is reduced or when the contents output in 2D, power consumed by a 3D conversion module (not shown) is reduced. Accordingly, a user can reduce the electricity service charge by properly controlling 3D output property (output attribute) of contents based on user selection or based on the electricity service charge (or response demand) while watching contents during a highest electricity service charge time period.

According to the fifth embodiment of the present invention, a user can save on an electricity service charge by properly changing the 3D output property (output attribute) of contents according to an electricity service charge (or response demand).

Meanwhile, a preview and/or a pre-listen according to a changed output property (output attribute) may be provided when the output property (output attribute) is changed according to embodiments of the present invention. For example, the DTV 100 provides the information window 65 for providing displaying sizes (output property) and corresponding electric service charges in order to allow a user to select as shown in FIG. 8. When a displaying size is pre-selected, a corresponding preview and/or a corresponding pre-listen may be provided.

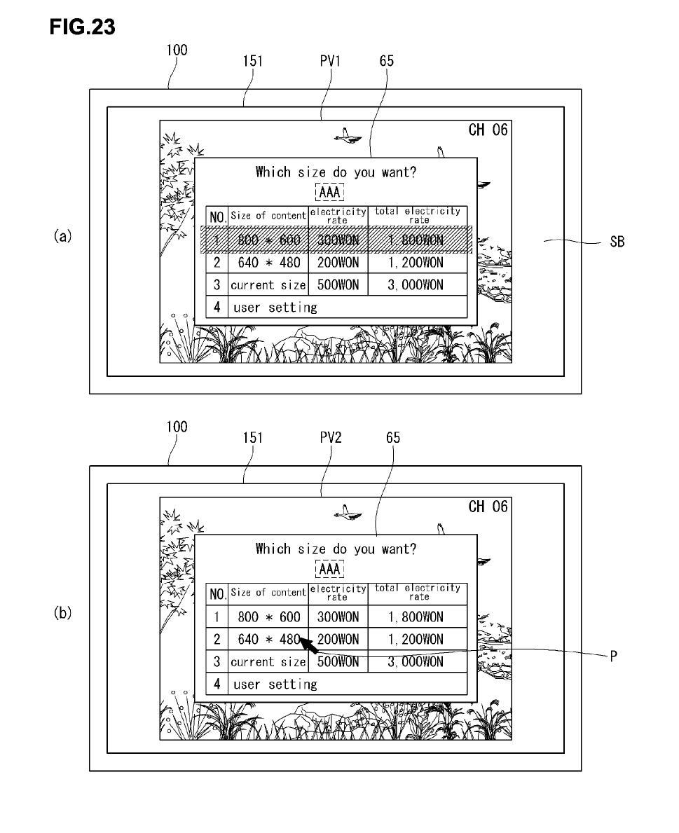

Hereinafter, a method for providing a preview or a pre-listen will be described with reference to FIGS. 22 and 23.

FIG. 22 is a flowchart that illustrates a method for providing a preview and/or a pre-listen according to an embodiment of the present invention.

The DTV 100 pre-selects an item corresponding to an output property (output attribute) to change at step S600. An item may be pre-selected through various methods.

For example, a selection bar (SB) may be provided for selecting a displaying size of contents as shown in a diagram (a) of FIG. 23. Items corresponding to displaying sizes of contents may be pre-selected according to the movement of the selection bar (SB). That is, items corresponding to a location of the selection bar may be preselected. The location of the selection bar (SB) may be moved according to the user input.

Referring to a diagram (b) of FIG. 23, a pointer (P) for selecting a displaying size of contents may be provided. Items corresponding to displaying sizes of contents may be pre-selected according to the movement of the pointer (P). That is, items corresponding to a location of the pointer (P) may be preselected. The location of the pointer (P) may be moved according to user input.

Meanwhile, the DTV 100 may preselect items based on additional conditions as well as the location of the selection bar or the pointer.

For example, when the selection bar (SB) or the pointer (P) stays a location corresponding to one of items for predetermined time duration, the DTV 100 may preselect items corresponding to the selection bar (SB) and/or the pointer (P). When the DTV 100 receives additional input from a user after the selection bar (SB) or the pointer (P) stays one of items, the DTV 100 may preselect the corresponding items.

When an item is preselected, the DTV 100 may provide a preview and/or a pre-listen by changing the output property (output attribute) of contents according to the output property (output attribute) corresponding to the preselected item at step S610.

For example, as shown in a diagram (a) of FIG. 23, the DTV 100 may provide a preview PV1 by controlling a displaying size of contents to ‘800*600’ which is a displaying size of the preselected item such as.

As shown in a diagram (b) of FIG. 23, the DTV 100 may provide a preview (PV2) by controlling a displaying size to ‘640*480’ which is a displaying size of the preselected item.

Accordingly, a user can select a proper output property (output attribute) because the user can confirm how the selected contents will be output based on the selected output property (output attribute) in advance.

At step S620, the DTV may finally select or may not select the preselected item. The preselected item can be finally selected through various methods.

For example, when the DTV 100 receives a selection signal to select the preselected items from a user, the DTV 100 may select the corresponding item. When a user moves the selection bar (SB) or the pointer (P), the DTV 100 may not select the preselected item.

When a user does not make any input during predetermined time duration, the DTV 100 may select the preselected item. For example, when a user does not make any input for about 5 seconds after preselecting items, the DTV 100 may select the preselected item. When a user makes a predetermined input after preselecting items, the DTV 10 may not select the preselected items.

When the preselected item is not finally selected, the DTV 100 may perform the above-described operations again by returning to the step S600.

On the contrary, when the preselected time is selected, the DTV 100 may output contents according to an output property corresponding to the selected item at step S630.

The method for providing a preview and a pre-listen was described based on the first embodiment that changes a displaying size of contents based on the electric service charge information and/or demand response information. However, the method for providing a preview and a pre-listen may be applied to the second to fifth embodiments of the present invention. For example, a pre-listen of a preselected sound volume may be provided when a sound volume of an electronic device is changed based on the electric service charge information and/or demand response information according to the third embodiment. Further, a preview may be provided according to a 3D output property (output attribute) of preselected contents according to the fifth embodiment.

Although the first to fifth embodiments of the present invention were described independently. However, it is obvious to ordinary skilled in the art that the first to fifth embodiments may be combined together. For example, the brightness of contents may be controlled at the same of reducing a displaying size of contents. Furthermore, the sound of contents may be controlled at the same time.

The embodiments of the present invention were described to reduce a displaying size of contents, to decrease brightness of contents, and to lower a sound volume of contents when an electric service charge is high. However, when an electric service charge is low, the embodiments of the present invention may enlarge a displaying size of contents, increase brightness of contents, and increase a sound volume of contents. Since ordinary skilled in the art can easily understand such a method of enlarging a displaying size of contents, increasing brightness of contents, and increasing a sound volume of contents based on the described embodiments of the present invention, detailed descriptions thereof are omitted herein.

A user may set the user interfaces of the embodiments of the present invention to be provided or not to be provided. For example, a user may set one of the user interfaces to be provided or not to be provided.

The reference value such as the first reference value and the second reference value related to the electric service charge may include a plurality of reference values. The first reference value may be equal to or different from the second reference value.

The reference value such as the first reference value and the second reference value may be pro-loaded by a manufacturer such as a DTV manufacturer, be set by a user, or be set based on information received from an external device.

The method for controlling an electronic device according to the embodiment of the present invention may be realized as a program. Such a program may be stored in a computer readable recording medium and performed by a computer.

The method for controlling an electronic device according to the embodiment of the present invention may be performed through software. When it is performed through software, constituent steps thereof are code segments that perform necessary operations. The program or the code segments may be stored in a computer readable recording medium. Further, the program or the code segments may be transmitted in a communication network by a computer data signal combined with a carrier.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device comprising:
a communication unit configured to receive per-timeslot electricity rate information; and
a controller configured to output a control signal to control an output attribute to output predetermined contents based on the received electricity rate information.

2. The electronic device of claim 1, wherein the output attribute includes at least one of a displayed size of the contents, a brightness for the contents displayed on the display unit, a sound volume of the contents, a saturation of the contents, and a 3D output attribute of the contents.

3. The electronic device of claim 2, wherein the controller is configured to output a control signal for resizing the displayed size based on the received electricity rate information.

4. The electronic device of claim 2, wherein the controller is configured to output a control signal for changing a resolution to display the contents on the display unit based on the electricity rate information.

5. The electronic device of claim 2, wherein the controller is configured to output a control signal for reducing or interrupting electric power supplied to a non-displayed area of the display unit, wherein the non-displayed area is an area where the contents are not displayed in the display unit.

6. The electronic device of claim 2, wherein the controller is configured to output a control signal for controlling the brightness based on the electricity rate information.

7. The electronic device of claim 2, wherein the controller is configured to receive information on surrounding illumination intensity and to output a control signal for controlling lighting devices and/or light shielding devices around the electronic device based on the received information on surrounding illumination intensity and the brightness of the contents.

8. The electronic device of claim 2, wherein the controller is configured to output a control signal for displaying subtitle information corresponding to the contents on the display unit based on the received electricity rate information instead of outputting the sound of the contents.

9. The electronic device of claim 2, wherein the electricity rate information includes demand response information.

10. An electronic device comprising:
a communication unit configured to receive per-timeslot electricity rate information; and
a controller configured to provide a graphical user interface for controlling output attribute for outputting contents when an electricity rate of a current time is higher than a predetermined reference value based on the received electricity rate information.

11. The electronic device of claim 10, wherein the graphic user interface is selectively provided by user setting.
